(19) United States
(12) Patent Application Publication
(10) Pub. No.: US 2024/0037301 A1
(43) Pub. Date: Feb. 1, 2024

(54) THREE-DIMENSIONAL ACID FRACTURING METHOD FOR CARBONATE RESERVOIRS IN LONG INTERVALS

(71) Applicant: Southwest Petroleum University, Chengdu City (CN)

(72) Inventors: Jianchun GUO, Chengdu City (CN); Bo GOU, Chengdu City (CN); Jichuan REN, Chengdu City (CN); Jie ZENG, Chengdu City (CN); Ting YU, Chengdu City (CN); Chi CHEN, Chengdu City (CN); Yingxian MA, Chengdu City (CN); Jie LAI, Chengdu City (CN); Xiao LI, Chengdu City (CN); Yu FAN, Chengdu City (CN); Weihua CHEN, Chengdu City (CN); Fei LIU, Chengdu City (CN)

(21) Appl. No.: 18/136,703

(22) Filed: Apr. 19, 2023

(30) Foreign Application Priority Data
Jul. 26, 2022 (CN) 202210887215.4

(51) Int. Cl. G06F 30/28; E21B 41/00; E21B 43/27; E21B 49/00; G06Q 10/0637; G06Q 50/02

(52) U.S. Cl. CPC G06F 30/28; E21B 41/00; E21B 43/27; E21B 49/00; G06Q 10/0637; G06Q 50/02; E21B 34/06

(57) ABSTRACT

The present invention relates to a three-dimensional acid fracturing method for carbonate reservoirs in long intervals, which sequentially comprises the following steps: S1: based on the distribution characteristics of porosity and permeability of the reservoir where the candidate well is located, the reservoirs are divided into Class I, Class II and Class III, and the required acid fracturing fracture density range ρᵢᵣ of different types of reservoirs is determined according to the increase of production; S2: Determine the most economical fracture number Ne when the economic net present value NPV of candidate wells reaches the maximum in the fifth year based on interval length of different types of reservoirs in candidate wells and acid fracturing fracture density range ρᵢᵣ determined by S1; S3: Determine the three-dimensional acid fracturing segmented fracture arrangement technology according to the completion mode of the candidate well and the most economical fracture number Ne determined by S2; S4: Based on the segmented joint distribution technology of three-dimensional acid fracturing determined by S3, the three-dimensional acid fracturing method of reservoir is determined. The present invention has reliable principle and simple operation, realizes the full utilization of reservoirs in long intervals and the full transformation of the reservoirs in the intervals are realized, provides technical means for the efficient production increase of oil and gas wells, and has broad market application prospects.

### TECHNICAL FIELD

The present invention relates to the technical field of petroleum engineering, in particular to a three-dimensional acid fracturing method for carbonate reservoirs in long intervals.

### BACKGROUND ART

Deep carbonate oil and gas are usually stored in millimeter-centimeter-level pore reservoirs, and the oil and gas reservoirs are usually not connected with the borehole, so oil and gas cannot be produced naturally. Acid fracturing technology is the key technology to build and increase production of carbonate oil and gas wells. Acid fracturing is to break the rock to form artificial cracks, and then inject acid to unevenly dissolve the wall of the cracks, forming uneven grooves; After the construction, under the action of closing pressure, the acid-undissolved area is used as the support point, forming acid-etched cracks with certain geometric size and conductivity, and realizing the construction of “oil and gas expressway” underground.

With the increasing demand for efficient and economic development of carbonate reservoirs, in recent years, carbonate reservoirs have adopted the development mode of “thin wells and high production”, and the application of ultra-long horizontal wells has become more and more. The reconstructed interval of super-long horizontal well (the length from target A at the root of horizontal well to target B at the end) is generally long (usually ≥1000 m), and the reservoir heterogeneity is extremely strong. In order to achieve high-efficiency stimulation, the three-dimensional acid fracturing technology is an innovative stimulation technology to fully transform the reservoir in the long interval horizontally and vertically (Guo Jianchun, Gou Bo, Qin Nan, Zhao Junsheng, Wu Lin, Wang Kunjie, Ren Jichuan. Innovation of deep carbonate reservoir reconstruction concept-three-dimensional acid fracturing technology [J]. Natural gas industry, 2020, 40 (02):61-74). Two key problems in the three-dimensional acid fracturing reconstruction of long-interval reservoir: first, how to choose the segmentation technology to separate the long-interval reservoir and realize the full utilization of the long-interval reservoir; the second is how to choose the acid fracturing technology in the interval to realize the full transformation of the reservoir in the interval. Unreasonable selection of subsection technology will not only lead to poor reservoir reconstruction effect, failure to fully release reservoir oil and gas production potential and low economic benefit, but also may lead to complex wellbore engineering accidents; the transformation in the interval is not strong enough, and it can not maximize the efficient production increase of oil and gas wells. However, at present, there is still a lack of three-dimensional acid fracturing methods that comprehensively consider the reservoir stimulation potential, the engineering conditions and economic benefits of long intervals, which affects the economic and efficient stimulation of oil and gas wells.

### SUMMARY OF THE INVENTION

An object of the present invention is to provide a three-dimensional acid fracturing method for carbonate reservoirs in long intervals. According to the strong heterogeneity of carbonate reservoirs in long intervals, the three-dimensional acid fracturing methods for carbonate reservoirs in long intervals under different completion modes are determined, so that the full utilization of the reservoirs in long intervals and the full transformation of the reservoirs in the intervals are realized, and technical means are provided for efficient production increase of oil and gas wells. The invention has reliable principle, simple operation and broad market application prospect.

In order to achieve the above technical objectives, the present invention adopts the following technical solutions.

A three-dimensional acid fracturing method for carbonate reservoirs in long intervals, sequentially comprising the following steps:
S1: based on the distribution characteristics of porosity and permeability of the reservoir where the candidate well is located, the reservoirs are divided into Class I, Class II and Class III, and the oil and gas production of different types of reservoirs under different acid fracturing densities is calculated by using the reservoir numerical simulation method, and the required acid fracturing density range ρᵢᵣ of different types of reservoirs is determined according to the production increase range;
S2: Determine the most economical fracture number Ne when the economic net present value NPV of candidate wells reaches the maximum in the fifth year based on interval length of different types of reservoirs in candidate wells and acid fracturing fracture density range ρᵢᵣ determined by S1;
S3: Determine the three-dimensional acid fracturing segmented fracture arrangement technology according to the completion mode of the candidate well and the most economical fracture number Ne determined by S2;
S4: Based on the segmented joint distribution technology of three-dimensional acid fracturing determined by S3, the three-dimensional acid fracturing method of reservoir is determined.

Preferably, the step S1 specifically comprises the following sub-steps:
S11: Based on the distribution characteristics of porosity and permeability of the reservoirs where the candidate wells are located, the reservoirs are divided into Class I, Class II and Class III, and the fifth-year production of different types of reservoirs with different acid fracturing densities is calculated by using Eclipse reservoir numerical simulation software, wherein the acid fracturing density is defined as:

$${ρ}_{i} = \frac{{N}_{i}}{{L}_{i}} \qquad ( 1 )$$

Wherein: ρi is the acid fracturing fracture density of Class I reservoir, bar/m; Ni is the number and number of acid fracturing fractures in Class I reservoir; Li is the interval length of type i reservoir, m; i is the type i reservoir, dimensionless;
S12: Determine the density range ρᵢᵣ of acid fracturing fractures required by different types of reservoirs. First, calculate the production growth rate by using the following formula:

$${r}_{{ρ}_{i}} = \frac{{q}_{{ρ}_{i}} - {q}_{{ρ}_{mini}}}{{q}_{{ρ}_{mini}}} \times 100 \% \qquad ( 2 )$$

Wherein: r_{ρi} is the production growth rate in the fifth year when the acid fracturing fracture density of type i reservoir is ρi, %; q_{ρi} is the production of type i reservoir when the acid fracturing fracture density is ρi, m ³; q_{ρmini} is the output when the acid fracturing fracture density of type i reservoir is the minimum ρₘᵢₙᵢ, m³;

Change the acid fracturing fracture density of different types of reservoirs, and calculate the output q_{ρi} corresponding to different acid fracturing fracture densities ρi. When the output growth range corresponding to adjacent fracture densities is ≤2%, the low value of these two adjacent fracture densities is the upper limit of the required acid fracturing fracture density range, and the adjacent low density value of the low value is the lower limit of the required acid fracturing fracture density range, thus determining the required acid fracturing fracture density range ρir for different types of reservoirs.

Preferably, the step S2 specifically comprises the following sub-steps:
S21: Based on the density range ρᵢᵣ of acid fracturing fractures required by different types of reservoirs determined by S1, the number range of acid fracturing fractures required by candidate wells is estimated according to the interval lengths l₁, l₂ and l₃ of different types of reservoirs:

$${N}_{cp} = {\sum }_{i = 1}^{i = 3} {ρ}_{ir} {l}_{i} + {N}_{s} \qquad ( 3 )$$

Wherein: N_{cp} is the number range of acid fracturing fractures required by candidate wells, bar; i is the type i reservoir, dimensionless; Nₛ is the number of fractures that need to be locally increased or decreased according to the distribution of reservoir types of candidate wells, bar.

Further, the determination of Nₛ follows three principles:
(1) When the number of cracks needs to be increased, Nₛ takes a positive value, and when the number of cracks needs to be reduced, Nₛ takes a negative value;
(2) When high-quality reservoirs and poor-quality reservoirs are adjacent to or staggered with each other, the fractures are arranged according to the acid fracturing fracture density required by poor-quality reservoirs, in which the reservoir quality from good to bad is: Class I reservoir, Class II reservoir and Class III reservoir;
(3) When there are tight zones divided between different types of reservoirs and the thickness of the tight zone is h≥40 m, the two sides of the tight zone (defined as porosity ϕ≤2%) are respectively distributed with fractures. If the tight zone needs to be distributed separately, the number of fractures is one.
S22: According to the number range N_{cp} of acid fracturing fractures required by S21 candidate wells, use Eclipse reservoir numerical simulation software to calculate the production of candidate wells with different acid fracturing fractures in five years, and calculate the economic net present value NPV of candidate wells with different fracturing fractures in the fifth year according to the following formula:

$$NPV = {\sum }_{j = 1}^{j = 5} \frac{{F}_{j}}{{( 1 + r )}^{j}} - {C}_{0} = {\sum }_{j = 1}^{j = 5} \frac{{q}_{Nj} {s}_{j} {e}_{j} - {C}_{j}}{{( 1 + r )}^{j}} - {C}_{0} \qquad ( 4 )$$

Wherein: NPV is the economic net present value of the fifth year when the number of acid fracturing fractures in candidate wells is N, ten thousand yuan; Fⱼ is the difference between the cash inflow and outflow in the j year, RMB 10,000; r is the discount rate of reservation, %; Cⱼ is the cost generated in the production process of oil and gas wells in the j year, RMB 10,000; q_{Nj} is the oil and gas production in the j year when the number of acid fracturing fractures is N, m³; sⱼ is the commodity rate of oil and gas in the j year, %; eⱼ is the oil and gas price in the j year, RMB 10,000/m³; C₀ is the initial investment cost, RMB 10,000;

When the economic net present value NPV reaches the maximum, the corresponding number of acid fracturing cracks is the most economical number Nₑ.

Further, C₀ is determined by the following formula:

C₀=e_{d}Hₘ+NVₐ(eₐ+e_{c})+Fₘ (5)

Where: e_{d} is the cost price per meter of well depth, such as drilling, logging, cementing and logging, and it is RMB 10,000/m; Hₘ is oil and gas well sounding, m; Vₐ is the volume of fracturing and acidizing working fluid, m³; Eₐ is the unit price of fracturing and acidizing working fluid, RMB 10,000/m³; e_{c} is the cost of fracturing truck set required for pumping this amount of fracturing acidizing working fluid, RMB 10,000/m³; Fₘ is other maintenance costs, RMB 10,000.

Preferably, the step S3 specifically comprises the following sub-steps:
S31: Based on the completion mode of the candidate wells, determine the maximum number of sliding sleeves Mₘₐₓ using the sliding sleeve staged acid fracturing process, and the process is as follows:

When the horizontal well is completed with open hole or casing perforation, and the downhole subsection tools are available, the sliding sleeve subsection acid fracturing technology is used to distribute the joints, so as to realize the reconstruction of multiple acid fracturing fractures in the long interval (Wu Peng, Deng Wei, Xu Gang, Guo Xiudong. Optimization Technology of subsection completion of ultra-deep horizontal wells in carbonate reservoir of Tahe Oilfield [J]. Chemical Management, 2013, (04): 10-1);

When the horizontal well is completed in open hole or liner, when there is no downhole sectional tool, the temporary plugging of the seam is generally turned to the sewing by craft, which forces the formation of multiple fractures in the long interval (Li Xinyong, Li Chunyue, Shen Xin, Zhao Bing, Zhang Xiong, Wang Shibin, Guo Jianchun. Acid fracturing technology design of three-layer temporary plugging of horizontal wells in Tahe Oilfield [J]. Drilling and production technology, 2021, 44 (03):52-55).

When the sliding sleeves are used for staged acid fracturing, the maximum number of sliding sleeves Mₘₐₓ is determined by the following formula according to the minimum demand of acid fracturing construction displacement at the end of horizontal wells and the wellhead construction pressure limit:

$$aH + {f}_{1} {L}_{1} + {f}_{1} {L}_{2} {\sum }_{M = 1}^{M = {M}_{max}} \frac{{D}_{1}^{3}}{{D}_{2}^{3}} + {10}^{- 6} \frac{8 {Q}^{2}}{{π}^{2}} {\sum }_{M = 1}^{M = {M}_{max}} \frac{1}{{D}_{2}^{4}} ( \frac{1}{2} ( 1 - \frac{{D}_{2}^{2}}{{D}_{1}^{2}} ) + {( 1 - \frac{{D}_{2}^{2}}{{D}_{1}^{2}} )}^{2} ) \text{?} - {10}^{- 8} \text{?} gH \leq η \text{?} \qquad ( 6 )$$

$${D}_{2} = {D}_{2 max} - ( M - 1 ) d \qquad ( 7 )$$

$$\text{?} \text{indicates text missing or illegible when filed}$$

Wherein: M is the number of sliding sleeves, sleeves; Mₘₐₓ is the maximum number of sliding sleeves that can be deployed under the minimum displacement requirement of target B at the end of horizontal well. η is the safety factor of wellhead construction pressure, dimensionless; ρₕₗ is the maximum limiting value of wellhead construction pressure, MPa; f₁ is the friction gradient produced when fracturing acidizing working fluid flows through wellbore tubing, MPa/m; α is the fracture extension pressure gradient, MPa/m; ρₐ is the acid density, kg/m³; H is the vertical depth of the candidate well, m; L₁ is the tubing length, m; L₂ is the length of sliding sleeve, m; D₁ is the inner diameter of tubing, m; D₂ is the inner diameter of the sliding sleeve, m; Q is the injection displacement, m³/s; g is the acceleration of gravity, m/s², d is the diameter tolerance of sliding sleeve, m; D₂ₘₐₓ is the maximum inner diameter of sliding sleeve, m;

The derivation process of equations (6)˜(7) is as follows.

Wellhead pressure during acid fracturing construction is:

pₕ=pₛ+p_{f}−pₐₕ (8)

Wherein: pₕ is the wellhead construction pressure, MPa; pₛ is the extension pressure of bottom hole fracture, MPa; p_{f} is the friction produced when fracturing acidizing working fluid flows through wellbore string, MPa; pₐₕ is the wellbore fluid injection pressure, MPa.

In Formula (8), the bottom hole fracture extension pressure pₛ and wellbore fluid injection pressure are calculated by the following formulas respectively:

pₛ=αH (9)

pₐₕ=10⁻⁶ρₛgH (10)

When the sliding sleeve is used for staged fracturing, the friction of fracturing acidizing working fluid in the wellbore consists of two parts, one is the friction p_{ft} generated by flowing through the tubing, and the other is the friction p_{fs}; generated by flowing through the sliding sleeve. When sliding sleeve staged fracturing is not used, the friction of fracturing acidizing working fluid in wellbore is mainly the friction caused by flowing through tubing. Existing:

p_{f}=p_{ft}+p_{fs} (11)

In Formula (11), the friction p_{ft} of fracturing and acidizing working fluid in tubing is calculated according to the following formula:

p_{ft}=f₁L₁ (12)

Wherein: p_{ft} is the friction produced by fracturing and acidizing working fluid in tubing, MPa; p_{fs} is the friction produced by fracturing and acidizing working fluid in the sliding sleeve, MPa; f₁ is the friction gradient of fracturing and acidizing working fluid in tubing, MPa/m; L₁ is the tubing length, m.

The inner diameter of the sliding sleeve is usually smaller than the inner diameter of the tubing (as shown in FIG. 1). The friction of fracturing and acidizing working fluid in the sliding sleeve consists of two parts, one part is the friction when flowing in the sliding sleeve, and the other part is the throttling friction when the fracturing and acidizing working fluid flows through the variable cross section due to the size difference between the sliding sleeve and the tubing, so it is easy to obtain:

$$\text{?} = {Mf}_{2} {L}_{2} + {10}^{- 6} M ( {ξ}_{1} \frac{{v}_{2}^{2}}{2 g} + {ξ}_{2} \frac{{v}_{2}^{2}}{2 g} ) \text{?} g \qquad ( 13 )$$

$$\text{?} \text{indicates text missing or illegible when filed}$$

Wherein: M is the number of sliding sleeves, one; f₂ is the friction gradient of fracturing and acidizing working fluid in the sliding sleeve, MPa/m; L₂ is the length m of the sliding sleeve; ξ₁ is the local sudden reduction of head loss coefficient, dimensionless; ξ₂ is the local sudden expansion of head loss coefficient, dimensionless; v₂ is the velocity of fracturing and acidizing working fluid in the sliding sleeve, m/s.

Where, the relationship between f₂ and f₁ is calculated according to the following formula:

$${f}_{2} = \frac{{D}_{1}^{3}}{{D}_{2}^{3}} {f}_{1} \qquad ( 14 )$$

ξ₁ and ξ₂ are calculated as follows:

$${ξ}_{1} = \frac{1}{2} ( 1 - \frac{{D}_{2}^{2}}{{D}_{1}^{2}} ) \qquad ( 15 )$$

$${ξ}_{2} = {( 1 - \frac{{D}_{2}^{2}}{{D}_{1}^{2}} )}^{2} \qquad ( 16 )$$

The flow rate of fracturing and acidizing working fluid in the sliding sleeve is:

$${v}_{2} = \frac{4 Q}{{πD}_{2}^{2}} \qquad ( 17 )$$

It is easy to get the friction in the sliding sleeve from equations (12)-(16) as follows:

$$\text{?} = {Mf}_{3} {L}_{2} \frac{{D}_{1}^{3}}{{D}_{2}^{3}} + {10}^{- 6} M \frac{8 {Q}^{2}}{{π}^{2} {D}_{2}^{4}} ( \frac{1}{2} ( 1 - \frac{{D}_{2}^{2}}{{D}_{1}^{2}} ) + {( 1 - \frac{{D}_{2}^{2}}{{D}_{1}^{2}} )}^{2} ) \text{?} \qquad ( 18 )$$

$$\text{?} \text{indicates text missing or illegible when filed}$$

From equations (7)-(11) and (17), it is easy to get that the wellhead construction pressure when using sliding sleeve diversion is as follows:

$$\text{?} = aH + {f}_{3} {L}_{3} + {Mf}_{1} {L}_{2} \frac{{D}_{1}^{3}}{{D}_{2}^{3}} + {10}^{- 6} M \frac{8 {Q}^{2}}{{π}^{2} {D}_{2}^{4}} ( \frac{1}{2} ( 1 - \frac{{D}_{2}^{2}}{{D}_{1}^{2}} ) + {( 1 - \frac{{D}_{2}^{2}}{{D}_{1}^{2}} )}^{2} ) \text{?} - {10}^{- 6} \text{?} gH \qquad ( 19 )$$

$$\text{?} \text{indicates text missing or illegible when filed}$$

According to the tolerance d, the diameter of the sliding sleeve gradually decreases from the maximum inner diameter of the target point A at the root of the horizontal well near the borehole to the target point B at the end of the horizontal well far away from the borehole, so the inner diameter of the sliding sleeve at any section is:

D₂=D₂ₘₐₓ−(M−1)d (21)

Therefore, the combined formula (19) and formula (20) become:

$${p}_{h} = aH + {f}_{1} {L}_{3} + {f}_{1} {L}_{2} {\sum }_{M = 1}^{M = {M}_{max}} \frac{{D}_{1}^{3}}{{D}_{2}^{3}} + {10}^{- 6} \frac{8 {Q}^{2}}{{π}^{2}} {\sum }_{M = 1}^{M = {M}_{max}} \frac{1}{{D}_{2}^{4}} ( \frac{1}{2} ( 1 - \frac{{D}_{2}^{2}}{{D}_{1}^{2}} ) + {( 1 - \frac{{D}_{2}^{2}}{{D}_{1}^{2}} )}^{2} ) \text{?} - {10}^{- 6} \text{?} gH \qquad ( 21 )$$

$$\text{?} \text{indicates text missing or illegible when filed}$$

In order to ensure the safety of acid fracturing construction, wellhead construction pressure is required to meet the following requirements:

pₕ≤ηpₕₗ (22)

Combining the formulas (20)-(22), it is easy to obtain the maximum number Mₘₐₓ of sliding sleeves that meet the minimum construction displacement of target B.
S32: Based on the most economical number of fractures Nₑ determined by S22 and the maximum number of sliding sleeves Mₘₐₓ determined by S31, determine the acid fracturing staged fracture distribution process for candidate wells, and the process is as follows:

When the horizontal well is equipped with downhole subsection tools, and when Nₑ≤Mₘₐₓ, the sliding sleeve subsection acid fracturing technology is used for joint distribution, and the number of sliding sleeves deployed is Nₑ; When Nₑ>Mₘₐₓ, the sliding sleeve is segmented+the seam in the segment is temporarily blocked to turn to the sewing of composite craft cloth, and the sliding sleeve is adopted. The number is Mₘₐₓ, and the number of seam temporary plugging is Nₑ−Mₘₐₓ;

When the horizontal well is not equipped with underground sectional tools, the seam is temporarily blocked and turned to industrial sewing, and the number of seam temporary plugging is Nₑ.

Preferably, the step S4 specifically comprises the following sub-steps:
S41: When there are multiple types of reservoirs in the interval, determine the ratio of ζᵢ the length lᵢ of each reservoir interval to the total length l of the interval:

$${ζ}_{i} = \frac{{l}_{i}}{l} \times 100 \%$$

Where: ζᵢ is the ratio of the length li of the well section of type i reservoir to the total length L of this section, %;

When there are three types of reservoirs in the interval, ζᵢ≥33%, indicating that the interval is dominated by type i reservoirs; When there are two types of reservoirs in the interval, ζᵢ≥50%, indicating that the interval is dominated by type i reservoirs;
S42: According to the reservoir types in the interval determined in S41, different methods of acid fracturing in the interval are determined:

The acid fracturing target of Class I reservoir is to remove the pollution near the well and dredge the fractures and caves in the near-well zone. Turning acid fracturing is adopted to remove the pollution near the well bore at a displacement of 2.0-3.0 m³/min, and then the maximum acid injection displacement is adopted according to the wellhead construction pressure to break through the near-well polluted zone and dredge the fractures and caves. The acid injection amount is determined at 1.0-1.5 m³/m according to the reservoir thickness;

The acid fracturing target of Class II reservoir is to make long fractures and improve the conductivity. Pre-fluid acid fracturing is adopted. First, the fractures are made with weakly reactive working fluid (such as fracturing fluid or authigenic acid), and then etched with gelled acid. The acid injection amount is 1.5-2.5 m³/m, and the weakly reactive working fluid is 50% of the acid consumption, and the acid injection is discharged.

The acid fracturing target of Class III reservoir is to make long fractures, and two-stage alternating acid fracturing is adopted, that is, weakly reactive working fluid and gelled acid are injected alternately in two stages, with the acid injection amount of 1.5-2.5 m³/m, the working fluid with weak reaction is 50% of the acid consumption, and the acid injection displacement is constructed with the maximum acid injection displacement according to the wellhead construction pressure.

Compared with the prior art, the invention has the following beneficial effects:

Aiming at the characteristic of strong heterogeneity of carbonate reservoir in long well section, based on the concept of geological engineering integration and the concept of three-dimensional reconstruction and production of long well section, the invention fully considers the personalized demand of heterogeneous reservoir for cracks, the influence of deep bad wellbore conditions on acid fracturing subsection operation, economic cost and other issues, and determines the three-dimensional acid fracturing method of long well section reservoir in different completion modes, which is beneficial to realizing the economic and efficient three-dimensional reconstruction of long well section reservoir.

### BRIEF DESCRIPTION OF THE DRAWINGS

FIG. 1 is the flow diagram of fracturing acidizing working fluid in tubing and sliding sleeve.

FIG. 2 is the production growth rate of different types of reservoirs under different acid fracturing artificial fracture densities.

FIG. 3 is the net present value under different number of cracks.

### DETAILED DESCRIPTIONS OF THE PREFERRED EMBODIMENTS

The invention will be further explained with the attached drawings and field application examples. It should be noted that the embodiments in this application and the technical features in the embodiments can be combined with each other without conflict. It should be pointed out that unless otherwise specified, all technical and scientific terms used in this application have the same meaning as commonly understood by ordinary technicians in the technical field to which this application belongs.

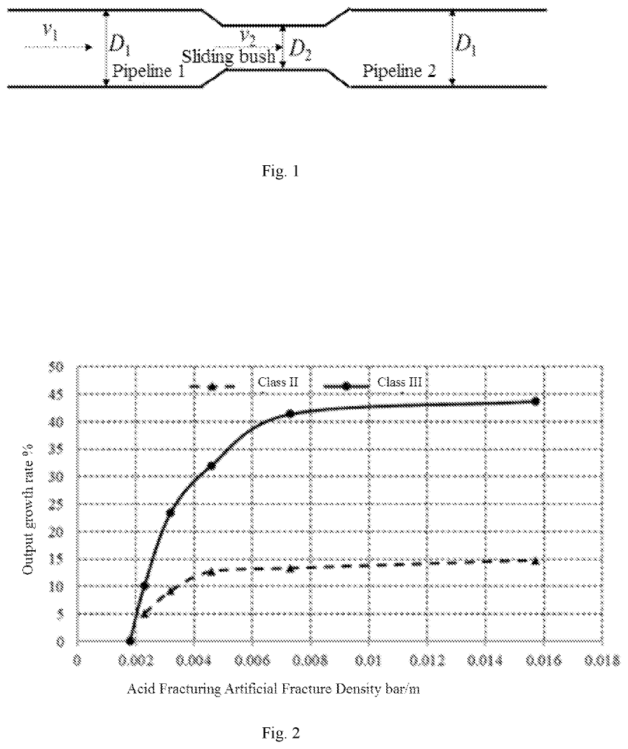

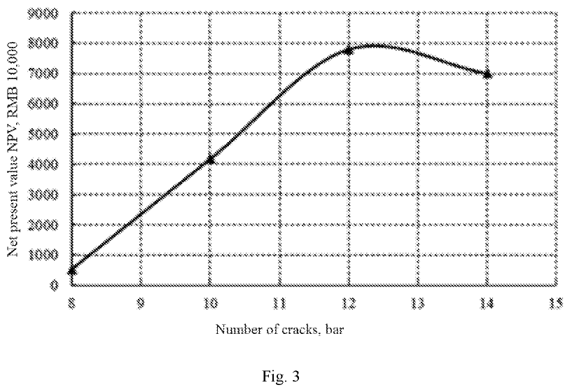

Refer to FIG. 1, FIG. 2 and FIG. 3.

A Three-dimensional acid fracturing method for carbonate reservoirs in long intervals, the specific process is as follows:

Carbonate X gas reservoir can be divided into two types according to porosity and permeability characteristics, as shown in Table 1. There is a horizontal well X9 drilled in this gas reservoir. The inclination depth of target A at the root of the horizontal interval is 5148 m, and the inclination depth of target B at the end far from the borehole is 7070 m. The length of the reformed interval is 1922 m, the formation pressure coefficient is 1.1, and the formation temperature is 153° C. The reservoir porosity, permeability and gas saturation explained by the reformed interval are shown in Table 2.

TABLE 1
Reservoir Classification of X Gas Reservoir

| Reservoir type | Porosity, % | Permeability, mD |
|---|---|---|
| Class II | 6~12 | 0.5~5.0 |
| Class III | 2~6 | 0.01~0.5 |

TABLE 2
Foundation Parameters of Well X9

| | | | | | | | | | | Sliding |
|---|---|---|---|---|---|---|---|---|---|---|
| | Top | Bottom | | | | | | | Packer | sleeve |
| Layer | depth | depth | Thickness | Porosity | Permeability | Water | Explain the | Reservoir | position | position |
| No. | m | m | m | % | mD | saturation % | conclusion | type | m | m |
| 1 | 5148 | 5156.6 | 8.6 | / | / | / | / | Dense zone | 5148.0 | |
| 2 | 5156.6 | 5203.7 | 47.1 | 3.1 | 0.16 | 13 | Poor gas layer | Class III | | |
| 3 | 5203.7 | 5225.2 | 21.5 | / | / | / | / | Dense zone | | |
| 4 | 5225.2 | 5234.8 | 9.6 | 2.8 | 0.11 | 25 | Air layer | Class III | | 5230.0 |
| 5 | 5234.8 | 5301 | 66.2 | / | / | / | / | Dense zone | 5270.0 | |
| 6 | 5301 | 5332 | 31 | 2.6 | 0.08 | 11 | Air layer | Class III | | |
| 7 | 5332 | 5359.4 | 27.4 | / | / | / | / | Dense zone | | |
| 8 | 5359.4 | 5422.9 | 63.5 | 2.8 | 0.14 | 8 | Poor gas layer | Class III | 5420.0 | 5370.0 |
| 9 | 5422.9 | 5524.5 | 101.6 | 2.4 | 0.07 | 16 | Air layer | Class III | | 5481.0 |
| 10 | 5524.5 | 5546.1 | 21.6 | / | / | / | / | Dense zone | 5535.0 | |
| 11 | 5546.1 | 5624.2 | 78.1 | 3.0 | 0.15 | 8 | Poor gas layer | Class III | | |
| 12 | 5624.2 | 5683.9 | 59.7 | 3.2 | 0.19 | 11 | Air layer | Class III | 5680 | 5630.0 |
| 13 | 5683.9 | 5716.4 | 32.5 | / | / | / | / | Dense zone | | |
| 14 | 5716.4 | 5872.1 | 155.7 | 2.5 | 0.09 | 20 | Air layer | Class III | | 5780.0 |
| 15 | 5872.1 | 5899.8 | 27.7 | / | / | / | / | Dense zone | 5890.0 | |
| 16 | 5899.8 | 6056.4 | 156.6 | 3.1 | 0.17 | 12 | Air layer | Class III | | 6005.0 |
| 17 | 6056.4 | 6069.2 | 12.8 | / | / | / | / | Dense zone | 6065.0 | |
| 18 | 6069.2 | 6098.2 | 29 | 2.2 | 0.04 | 17 | Poor gas layer | Class III | | |
| 19 | 6098.2 | 6113.8 | 15.6 | / | / | / | / | Dense zone | | |
| 20 | 6113.8 | 6191.5 | 77.7 | 2.4 | 0.07 | 10 | Poor gas layer | Class III | | 6149.0 |
| 21 | 6191.5 | 6457.2 | 265.7 | / | / | / | / | Dense zone | 6240.0 | 6325.0 |
| | | | | | | | | | 6450 | |
| 22 | 6457.2 | 6675 | 217.8 | 2.5 | 0.09 | 12 | Poor gas layer | Class III | | 6518.0 |
| 23 | 6675 | 6746.9 | 71.9 | / | / | / | / | Dense zone | 6725.0 | |
| 24 | 6746.9 | 6957.7 | 210.8 | 3.0 | 0.15 | 12 | Air layer | Class III | | 6870.0 |
| 25 | 6957.7 | 6988.7 | 31 | / | / | / | / | Dense zone | | |
| 26 | 6988.7 | 7016.9 | 28.2 | 2.6 | 0.10 | 14 | Air layer | Class III | | |
| 27 | 7016.9 | 7070 | 53.1 | / | / | / | / | Dense zone | 7070.0 | |

A. According to the characteristics of Class II reservoir of X gas reservoir and the reservoir range controlled by single well, the box geological model is established by using Eclipse software according to the invention patent “A method for evaluating staged acid fracturing effect of carbonate open-hole horizontal wells” (CN110094196B), and the model is 1000 m length, 1000 m width and 30 m thickness. The fifth-year cumulative production of Class II and Class III reservoirs under six kinds of artificial fracture densities (0.0018 bar/m, 0.0023bar/m, 0.0046 bar/m, 0.0073 bar/m and 0.0157 bar/m) are calculated respectively, and the production is calculated according to Formula (2). When the production increase range of adjacent fracture density is ≤2%, the corresponding acid fracturing fracture density is the optimal acid fracturing fracture density. According to FIG. 2, the required acid fracturing artificial fracture density of Class II reservoir in X gas reservoir ranges from 0.0032˜0.0046 bar/m, and that of Class III reservoir ranges from 0.0046˜0.0073 bar/m.
B. According to the length (thickness, Table 2) of different types of reservoirs in Well X9 and the required artificial fracture density of acid fracturing in Class III reservoir of X gas reservoir ranging from 0.0046˜0.0073bar/m, the estimated number of acid fracturing fractures in Well X9 ranges from 10˜13 according to Formula (3) and S21 fracture deployment principle.
C. According to the range of 10˜13 acid fracturing fractures determined by B, based on the geological characteristics of X9 reservoir (Table 2), the annual cumulative production of Well X9 with 10˜13 artificial acid fracturing fractures in 5 years is calculated by using Eclipse software. Basic parameter table 3 calculated from the net present value, and the economic net present value (FIG. 3) under different number of cracks is calculated according to formula (4). According to the economic net present value, the most economical number of fractures Nₑ in Well X9 is 12.

TABLE 3
Main Basis for Calculating Economic Net Present Value

| | | | |
|---|---|---|---|
| Commodity | 92 | Unit price of natural | 1.416 × 10⁻⁴ |
| rate of | | gas eⱼ, RMB | |
| natural gas sⱼ, % | | 10,000/m³ | |
| The cost of | 1.5195 | Unit price eₐ | 0.2 |
| drilling, logging, | | of fracturing and | |
| cementing, logging, | | acidizing working | |
| etc. e_{d}, | | fluid, RMB | |
| RMB10,000/m. | | 10,000/m³ | |
| Cost of fracturing | 0.1 | Other maintenance | 1596.6 |
| and acidizing | | costs Fₘ, RMB | |
| vehicle group e_{c}, | | 10,000 | |
| RMB 10,000/m³ | | | |
| The cost Cⱼ in the | 113.4 | Discount | 10 |
| process of natural gas | | rate r, % | |
| production, | | | |
| RMB10,000/year. | | | |

D. According to the requirements of minimum construction displacement and wellbore string conditions in target B interval of Well X9, the basic parameters are shown in Table 4, and the maximum number of sliding sleeves Mₘₐₓ is calculated as 10 according to Formula (6) and Formula (7); However, the number of the most economical cracks Ne determined by C is 12, so X9 needs to adopt sliding sleeve segmentation+temporary plugging of the seam in the segment to realize the most economical number of cracks Ne, and the number of temporary plugging of the seam is twice.

TABLE 4
Basic Parameters for Calculating the Number of Sliding Sleeves

| | | | |
|---|---|---|---|
| Safety factor η | 0.9 | Maximum limiting | 105 |
| of wellhead | | pressure of wellhead | |
| construction | | construction | |
| pressure, | | pressure | |
| dimensionless | | ρₕₗ, MPa | |
| Friction gradient | 0.0061 | Fracture extension | 0.0185 |
| f₁ generated | | pressure gradient α, | |
| when acid flows | | MPa/m | |
| through tubing, | | | |
| MPa/m | | | |
| Acid density ρₐ, | 1110 | Vertical depth | 5143.0 |
| kg/m³ | | of candidate | |
| | | well H, m; | |
| Tubing length L₁, m | 7060 | Sleeve string | 0.66 |
| | | length L₂, m | |
| Internal diameter of | 0.076 | Maximum inner | 0.06055 |
| tubing D₁, m | | diameter of sliding | |
| | | sleeve D₂ₘₐₓ, m | |
| Inner diameter | 0.00266 | Target B | 5.0 |
| tolerance of | | liquid injection | |
| sliding sleeve d, m | | displacement | |
| | | Q, m³/s | |
| Gravity acceleration | 9.8 | | |
| g, m/s² | | | |

E. According to the three-dimensional acid fracturing segmented joint distribution technology determined by D, the open hole packer+sliding sleeve split-flow segmentation method is adopted for Well X9, in which the packer is divided into 10 sections, and the packer is mainly located in the tight zone and the sliding sleeve is mainly located in the reservoir, in which the two sections of 6450-6725 and 6725-7070 are temporarily blocked at one time to increase the number of fractures. Except for the dense bar in 6240-6450 sections, the thickness of Class III reservoirs in other sections accounts for more than 50%. Therefore, the three-dimensional acid fracturing technology used in the section is: adopting the mode of two-stage alternate injection of autogenous acid and gelled acid, with the acid injection amount of 2.0 m³ per meter interval and the autogenous acid amount of 1.0 m³ per meter interval, and the construction displacement is constructed according to the maximum construction displacement under wellhead pressure limitation. The tested production of this well after acid fracturing is 61.6×10⁴ m³/d, which is 1.8 times that of the same reservoir in the adjacent well without using this technology, thus achieving the purpose of increasing production economically and efficiently.

Although the present invention has been disclosed in terms of preferred embodiments, it is not intended to limit the present invention. Any person familiar with this field can make some changes or modifications to equivalent embodiments by using the technical contents disclosed above without departing from the scope of the technical scheme of the present invention. However, any simple modifications, equivalent changes and modifications made to the above embodiments according to the technical essence of the present invention are still within the scope of the technical scheme of the present invention.

1. A three-dimensional acid fracturing method for carbonate reservoirs in long intervals, sequentially comprising the following steps:
S1: based on the distribution characteristics of porosity and permeability of the reservoir where the candidate well is located, the reservoirs are divided into Class I, Class II and Class III, and the required acid fracturing fracture density range ρᵢᵣ of different types of reservoirs is determined according to the increase of production;
S2: Determine the most economical fracture number Ne when the economic net present value NPV of candidate wells reaches the maximum in the fifth year based on interval length of different types of reservoirs in candidate wells and acid fracturing fracture density range ρᵢᵣ determined by S1;
S3: Determine the three-dimensional acid fracturing segmented fracture arrangement technology according to the completion mode of the candidate well and the most economical fracture number Nₑ determined by S2;
S4: Based on the segmented joint distribution technology of three-dimensional acid fracturing determined by S3, the three-dimensional acid fracturing method of reservoir is determined.

2. The three-dimensional acid fracturing method for carbonate reservoirs in long intervals according to claim 1, characterized in that the step S1 comprises the following sub-steps:
S11: Based on the distribution characteristics of porosity and permeability of the reservoirs where the candidate wells are located, the reservoirs are divided into Class I, Class II and Class III, and the fifth-year production of different types of reservoirs with different acid fracturing densities is calculated by using Eclipse reservoir numerical simulation software, wherein the acid fracturing density is defined as:
$${ρ}_{i} = \frac{{N}_{i}}{{L}_{i}}$$
Wherein: ρi is the acid fracturing fracture density of Class i reservoir, strips/m; Ni is the number and number of acid fracturing fractures in Class i reservoir; Li is the interval length of Class i reservoir, m; i is the type i reservoir, dimensionless;
S12: Determine the density range ρᵢᵣ of acid fracturing fractures required by different types of reservoirs. First, calculate the production growth rate by using the following formula:
$${r}_{{ρ}_{i}} = \frac{{q}_{{ρ}_{i}} - {q}_{{ρ}_{min , i}}}{{q}_{{ρ}_{min , i}}} \times 100 \%$$
Wherein: r_{ρi} is the production growth rate in the fifth year when the acid fracturing fracture density of Class i reservoir is ρi,%; q_{ρi} is the production of type i reservoir when the acid fracturing fracture density is ρi, m³; q_{ρmini} is the output when the acid fracturing fracture density of Class i reservoir is the minimum ρₘᵢₙᵢ, m³;
Change the acid fracturing fracture density of different types of reservoirs, and calculate the output q_{ρi} corresponding to different acid fracturing fracture densities ρi. When the output growth range corresponding to adjacent fracture densities is ≤2%, the low value of these two adjacent fracture densities is the upper limit of the required acid fracturing fracture density range, and the adjacent low density value of the low value is the lower limit of the required acid fracturing fracture density range, thus determining the required acid fracturing fracture density range ρir for different types of reservoirs.

3. The three-dimensional acid fracturing method for carbonate reservoirs in long intervals according to claim 1, characterized in that the step S2 comprises the following sub-steps:
S21: According to the interval lengths l₁, l₂ and l₃ of different types of reservoirs, estimate the number range of acid fracturing fractures required by candidate wells:
$${N}_{cp} = {\sum }_{i = 1}^{i = 3} {ρ}_{ir} {l}_{i} + {N}_{s}$$
Wherein: N_{cp} is the number range of acid fracturing fractures required by candidate wells; i is the type i reservoir, dimensionless; Nₛ is the number of fractures that need to be locally increased or decreased according to the distribution of reservoir types of candidate wells, bar;
S22: According to the number range N_{cp} of acid fracturing fractures required by S21 candidate wells, use Eclipse reservoir numerical simulation software to calculate the production of candidate wells with different acid fracturing fractures in five years, and calculate the economic net present value NPV of candidate wells with different fracturing fractures in the fifth year according to the following formula:
$$NPV = {\sum }_{j = 1}^{j = 5} \frac{{F}_{j}}{{( 1 + r )}^{j}} - {C}_{0} = {\sum }_{j = 1}^{j = 5} \frac{{q}_{Nj} {s}_{j} {e}_{j} - {C}_{j}}{{( 1 + r )}^{j}} - {C}_{0}$$
Wherein: NPV is the economic net present value of the fifth year when the number of acid fracturing fractures in candidate wells is N, ten thousand yuan; Fⱼ is the difference between the cash inflow and outflow in the j year, RMB 10,000; r is the discount rate of reservation, %; Cⱼ is the cost generated in the production process of oil and gas wells in the j year, RMB 10,000; q_{Nj} is the oil and gas production in the j year when the number of acid fracturing fractures is N, m³; sⱼ is the commodity rate of oil and gas in the j year, %; eⱼ is the oil and gas price in the j year, RMB 10,000/m³; C₀ is the initial investment cost, RMB 10,000;
When the economic net present value NPV reaches the maximum, the corresponding number of acid fracturing cracks is the most economical number Nₑ.

4. The three-dimensional acid fracturing method for carbonate reservoirs in long intervals according to claim 3, characterized in that the determination of Nₛ follows three principles:
(1) When the number of cracks needs to be increased, Nₛ takes a positive value, and when the number of cracks needs to be reduced, Nₛ takes a negative value;
(2) When high-quality reservoirs and poor-quality reservoirs are adjacent to or staggered with each other, the fractures are arranged according to the acid fracturing fracture density required by poor-quality reservoirs, in which the reservoir quality from good to bad is: Class I reservoir, Class II reservoir and Class III reservoir;
(3) When there is a dense zone division between different types of reservoirs and the thickness of the dense zone is more than or equal to h≥40 m, the fractures are distributed on both sides of the dense zone respectively. If the dense zone needs to be distributed separately, the number of fractures is one.

5. The three-dimensional acid fracturing method for carbonate reservoirs in long intervals according to claim 1, characterized in that step S3 comprises the following sub-steps:
S31: Based on the completion mode of candidate wells, when the sliding sleeves are used for staged acid fracturing, the maximum number of sliding sleeves Mₘₐₓ is determined by the following formula according to the minimum demand of acid fracturing construction displacement at the end of horizontal wells and the wellhead construction pressure limit:
$$aH + {f}_{1} {L}_{1} + {f}_{1} {L}_{2} {\sum }_{M = 1}^{M = {M}_{max}} \frac{{D}_{1}^{3}}{{D}_{2}^{3}} + {10}^{- 6} \frac{8 {Q}^{2}}{{π}^{2}} {\sum }_{M = 1}^{M = {M}_{max}} \frac{1}{{D}_{2}^{4}} ( \frac{1}{2} ( 1 - \frac{{D}_{2}^{2}}{{D}_{1}^{2}} ) + {( 1 - \frac{{D}_{2}^{2}}{{D}_{1}^{2}} )}^{2} ) \text{?} - {10}^{- 6} \text{?} gH \leq η \text{?}$$
$${D}_{2} = {D}_{2 max} - ( M - 1 ) d$$
$$\text{?} \text{indicates text missing or illegible when filed}$$
Wherein: M is the number of sliding sleeves, sleeves; Mₘₐₓ is the maximum number of sliding sleeves that can be deployed under the minimum displacement requirement of target B at the end of horizontal well. η is the safety factor of wellhead construction pressure, dimensionless; ρₕₗ is the maximum limiting value of wellhead construction pressure, MPa; f₁ is the friction gradient produced when fracturing acidizing working fluid flows through wellbore tubing, MPa/m; α is the fracture extension pressure gradient, MPa/m; ρₐ is the acid density, kg/m³; H is the vertical depth of the candidate well, m; L₁ is the tubing length, m; L₂ is the length of sliding sleeve, m; D₁ is the inner diameter of tubing, m; D₂ is the inner diameter of the sliding sleeve, m; Q is the injection displacement, m³/s; g is the acceleration of gravity, m/s², d is the diameter tolerance of sliding sleeve, m; D₂ₘₐₓ is the maximum inner diameter of sliding sleeve, m;
S32: Based on the most economical number of fractures Nₑ determined by S22 and the maximum number of sliding sleeves Mₘₐₓ determined by S31, determine the acid fracturing staged fracture distribution process for candidate wells, and the process is as follows:
When the horizontal well is equipped with downhole subsection tools, and when Nₑ<Mₘₐₓ, the sliding sleeve subsection acid fracturing technology is used for joint distribution, and the number of sliding sleeves deployed is Nₑ; When Nₑ>Mₘₐₓ, the sliding sleeve is segmented+the seam in the segment is temporarily blocked to turn to the sewing of composite craft cloth, and the sliding sleeve is adopted. The number is Mₘₐₓ, and the number of seam temporary plugging is Nₑ−Mₘₐₓ;
When the horizontal well is not equipped with underground sectional tools, the seam is temporarily blocked and turned to industrial sewing, and the number of seam temporary plugging is Nₑ.

6. The three-dimensional acid fracturing method for carbonate reservoirs in long intervals according to claim 1, characterized in that step S4 comprises the following sub-steps:
S41: When there are multiple types of reservoirs in the interval, determine the ratio of ζᵢ the length lᵢ of each reservoir interval to the total length l of the interval:
$${ζ}_{i} = \frac{{l}_{i}}{l} \times 100 \%$$
When there are three types of reservoirs in the interval, ζᵢ≥33%, indicating that the interval is dominated by type i reservoirs; When there are two types of reservoirs in the interval, ζᵢ≥50%, indicating that the interval is dominated by type I reservoirs;
S42: According to the reservoir types in the interval determined in S41, different methods of acid fracturing in the interval are determined:
The acid fracturing target of Class I reservoir is to remove the pollution near the well and dredge the fractures and caves in the near-well zone. Turning acid fracturing is adopted to remove the pollution near the well bore at a displacement of 2.0-3.0 m³/min, and then the maximum acid injection displacement is adopted according to the wellhead construction pressure to break through the near-well polluted zone and dredge the fractures and caves. The acid injection amount is determined at 1.0-1.5 m³/m according to the reservoir thickness;
The acid fracturing target of Class II reservoir is to make long fractures and improve the conductivity. Pre-fluid acid fracturing is adopted. First, the fractures are made with weakly reactive working fluid and then etched with gelled acid. The acid injection amount is 1.5-2.5 m³/m, and the weakly reactive working fluid is 50% of the acid consumption, and the acid injection is discharged.
The acid fracturing target of Class III reservoir is to make long fractures, and two-stage alternating acid fracturing is adopted, that is, weakly reactive working fluid and gelled acid are injected alternately in two stages, with the acid injection amount of 1.5-2.5 m³/m, the working fluid with weak reaction is 50% of the acid consumption, and the acid injection displacement is constructed with the maximum acid injection displacement according to the wellhead construction pressure.
